(19) United States
(12) Patent Application Publication
(10) Pub. No.: US 2021/0379967 A1
(43) Pub. Date: Dec. 9, 2021

(54) HEAT EXCHANGER DEVICE FOR THE PROVISION OF REFRIGERATION IN REFRIGERATED VEHICLES, THE MOTOR VEHICLE ENGINE OF WHICH IS OPERATED BY LNG

(71) Applicant: REGASCOLD GmbH, Roetha OT Espenhain (DE)

(72) Inventors: Rainer BRAUN, Haltern am See (DE); Peter OTTO, Wermsdorf (DE); Lothar BIHL, Bad Saulgau (DE)

(73) Assignee: REGASCOLD GmbH, Roetha OT Espenhain (DE)

(21) Appl. No.: 16/956,851

(22) PCT Filed: Dec. 5, 2018
(86) PCT No.: PCT/DE2018/000360

§ 371 Date: Jun. 22, 2020

(30) Foreign Application Priority Data
Dec. 29, 2017 (DE) 10 2017 012 125.7

(51) Int. Cl. B60H 1/32; B60H 1/00; F17C 9/04

(52) U.S. Cl. CPC B60H 1/3202; B60H 1/00328; F17C 9/04; B60H 1/00014; F17C 2221/033; F17C 2270/0171; F17C 2225/0123; F17C 2227/0311; F17C 2227/0323; F17C 2260/046; F17C 2265/066; F17C 2223/0161

(57) ABSTRACT

A heat exchanger device provides refrigeration in refrigerated vehicles operated by liquefied natural gas (LNG) which must first be regasified. The great temperature difference between heat-discharging cooling chamber air and heat-absorbing LNG evaporating at up to −161° C. conducts the heat flow via an introduced intermediate medium circulating in a closed circuit to avert the risk of combustible natural gas leaking. The intermediate medium is non-combustible, environmentally-benign liquid heat exchange media having low viscosity. The liquid heat exchange media operating temperature is kept above −85° C. using an additional thermal resistance in the heat exchanger which evaporates the LNG, so that the heat flow flows with sufficient temperature drop. A thin protective dry gas layer formed using sheathing tubes enclosing a tubular heat exchanger's tubes coaxially serves as this thermal resistance. Possibly escaping natural gas is determined by monitoring pressure in the layer, and the LNG supply interrupted.

### FIELD OF USE

The invention relates to the provision of refrigeration for refrigerated vehicles that utilize cryogenic liquefied natural gas LNG (liquified natural gas) as the operating energy.

### STATE OF THE ART

Cryogenic liquefied natural gas that is used for the operation of motor vehicle engines is usually evaporated for the purpose of re-gasification, using ambient air and/or waste engine heat. The energetically valuable refrigeration energy that is released during this process remains unutilized in many cases, but this does not necessarily have to be true. Instead, this energy should be recovered and made available to the refrigerated vehicle as transport refrigeration.

The state of the art provides the following technical solutions in this regard, which have been documented in patents.

In the documents DE 195 31 122 and EP 0 788 908, a cooling device is described, which cools the transport chamber of a refrigerated vehicle, the motor vehicle engine of which is operated using re-gasified LNG. The cryogenic LNG that is carried on the vehicle in a refrigeration-insulated tank is pumped into the transport chamber by way of a hermetically sealed system and evaporated there in a heat exchanger, by means of heat absorption out of the re-circulated transport chamber air. In addition, a latent refrigeration storage unit is switched in parallel with this heat exchanger, which unit also gives off heat from the storage unit material to the hermetically sealed LNG to be evaporated. Finally, the evaporated LNG flows to the engine as a gaseous fuel.

If the LNG flow is interrupted when the engine is shut off, cooling of the transport chamber can be maintained using the refrigeration storage unit, in that the re-circulated chamber air heats the storage unit mass. In the document, a semi-trailer having a truck unit that contains the LNG tank and having a trailer that contains the transport chamber having the air cooler and the refrigeration unit are shown. The line that supplies liquid LNG and the line that carries away evaporated LNG, and thereby also connects the truck unit and the trailer, can be separated from one another without leaks, using couplings, under prevailing operating pressure. When the LNG flow is then interrupted, the refrigeration storage unit can continue cooling. The proposed cooling technology has the advantage of a very simple structure. However, this is offset by a significant disadvantage, namely that the entire system, consisting of the pump, the lines, the couplings, and the heat exchangers, is exposed to the risk that the reduced material strength that accompanies the low temperature of the LNG, going as low as −161° C., causes leaks that lead to the result that combustible natural gas gets into the transport chamber and into the surroundings of the transport vehicle.

In DE 10 2010 020 476, a refrigerated vehicles operated with cryogenic LNG is also described, in which an additional tank that contains cryogenic liquefied nitrogen is carried along in parallel to the LNG tank, with acceptance of a significant cost expenditure. Re-gasification of this nitrogen makes valuable refrigeration energy for the refrigerated goods stored in the transport chamber available in a heat exchanger provided for this purpose, specifically not only during travel operation but also during stops when the engine is shut off, wherein the resulting gaseous nitrogen is harmlessly carried away to the surroundings. Parallel or alternative use of the refrigeration energy released by the re-gasification of the cryogenic LNG takes place during operation of the engine, with the weighty hazard potential of the combustible natural gas as described above.

Finally, a technical solution is proposed in the documents WO 2011/141287 and US 2013/0055728, for refrigerated vehicles that are operated using cryogenic LNG, which solution works with a liquid, non-combustible intermediate medium for recovery of the refrigeration energy and thereby excludes the hazard in the region of the transport chamber that proceeds from the natural gas. A semi-trailer having a truck unit and a trailer in which the transport chamber to be cooled is situated, as usual, is shown. In this chamber, the heat to be carried away from re-circulated air for the purpose of cooling is transferred to the intermediate medium in a heat exchanger. This medium is circulated in a closed heat transfer circuit, using a pump; however, this circuit can be separated using couplings and partially flexible lines. In this regard, the intermediate medium transports the absorbed heat to a second heat exchanger, placed on the truck unit close to the LNG storage unit and the internal combustion engine, so as to transfer it here to the LNG that is supplied using a pump. As far as the hazard potential of the material stress caused by the low temperature, on the one hand, and the combustible natural gas, on the other hand, is concerned, the compact arrangement, making do with short supply lines, of the components to which LNG is applied, on the truck unit, can be considered advantageous. However, the proposed method of transfer of heat to the LNG has a significant disadvantage. It takes place recuperatively by way of a wall that separates the intermediate medium and the LNG. The surface temperature of this wall, on the side impacted by the intermediate medium, differs only very slightly from the temperature of the LNG, due to the very low transport resistance of the heat conduction through the thin wall, on the one hand, and the heat transfer to the evaporating LNG, on the other hand. For this reason, the intermediate medium must have a composition such that it does not freeze and remains capable of flow down to the temperature of the LNG, in other words down to −161° C. Such a liquid intermediate medium, for which the additional requirement exists that in the event of leakage, it is not harmful to the environment, in particular to the refrigerated goods stored in the transport chamber, is only available with extremely great restrictions and furthermore also only at very great expense.

Furthermore, its conveyance to the heat exchanger of the transport chamber requires great pump power due to the low temperature and the high viscosity of the intermediate medium that results from this temperature. The proposed technology is therefore also not satisfactory.

### Statement of Task

The statement of task of the invention is derived from the state of the art as described above, in particular from its disadvantages.

This task consists essentially of the development of a heat transfer device for provision of transport refrigeration for refrigerated vehicles that are operated using cryogenic liquefied natural gas. In this regard, heat is to be extracted from the cooling chamber and the refrigerated goods contained in it by means of air circulation, and subsequently transferred to the evaporated LNG, but this of course requires that the very low temperature level of the LNG, which can amount to as low as −161° C., is reliably controlled. In particular, the hazard must be averted that in the event of damage, natural gas NG ([in English:] natural gas) enters into the cooling chamber of the refrigerated vehicle and/or into a closed space in which the refrigerated vehicle might be parked. If the cooling chamber is situated in the trailer of a semi-trailer, it must additionally be taken into consideration that the truck unit on which the LNG tank is situated can be easily separated from the trailer.

Suitable technical means must be indicated to accomplish these tasks.

### Solution for the Statement of Task

The solution for the statement of task is indicated in claim 1. The dependent claims contain practical embodiments.

The invention makes use of the circumstance that the cooling air in the transport chamber of the refrigerated vehicle only needs to be cooled to at most −30° C., in other words that a very great driving temperature difference is available for heat transport to the LNG, which makes it possible to guide the heat transfer by way of a liquid intermediate medium, so as to thereby guard against the hazard potential caused by the low temperature level of the LNG, in other words against the reduction in material strength and against the possible leakage of combustible gas.

For this purpose, the thermal resistance becomes Rₜₕ=ΔT/\dot{Q}, in other words the quotient of the driving temperature difference ΔT that decreases at the resistance Rₜₕ and of the heat energy \dot{Q} of the recuperative heat exchanger to be transferred, at which exchanger the evaporation of the LNG takes place, is increased in targeted manner, so that the temperature of the wall that separates the heat-discharging material stream from the heat-absorbing material stream is so high on the surface facing away from the LNG that the intermediate medium that wets it does not freeze and is reliably capable of flow. If the permissible cooling of the intermediate medium is not required to be too low, for example only down to −85° C., suitable heat media are very well available.

The liquid intermediate medium, conveyed in the closed heat medium circuit by a re-circulation pump, makes an active connection possible between the air cooler in the transport chamber and the LNG evaporator, in spite of strict spatial separation, and thereby makes it possible to have a compactly combined, easily safeguarded arrangement of the components to which cryogenic LNG is applied: the LNG storage unit, LNG pump, and LNG heat exchanger, for example on the truck unit of a semi-trailer, and at the same time offers a short line pathway for the combustible natural gas produced by means of re-gasification to the internal combustion engine. Furthermore, the environmental friendliness of the intermediate medium makes it possible for the circuit, which is conducted in insulated, partially flexible lines, to be opened using quick-lock couplings that shut off on both sides, so as to separate the trailer of a semi-trailer from the truck unit, for example.

It is advantageous if the heat transfer to the LNG takes place in a pipe-bundle heat exchanger produced from a cryogenic material, which exchanger conducts the LNG to be evaporated in the pipes and conducts the heat-discharging intermediate medium in the mantle chamber, and is structured in such a manner that the great temperature changes, in terms of time and place, that occur during operation do not cause any uncontrollable mechanical stresses. A pipe-bundle heat exchanger having a floating head and two mantle paths is advantageously suitable.

The invention proposes inserting an additional thermal resistance, which expands the resistance usually present in targeted manner, into the pipe-bundle heat exchanger. This resistance is achieved, according to the invention, by means of the placement of coaxially running protective pipes, which sheathe the heat transfer pipes that carry the LNG, in such a manner that a hermetically sealed interstice to be filled with a dry gas, for example nitrogen or air, is formed, the low layer thickness of which, between the pipes, should be designed in such a manner that the desired sufficiently high temperature occurs on the surface of the protective pipe that faces the intermediate medium.

As a further safety-technology measure, it is proposed to select the pressure of the dry gas hermetically sealed between the coaxial pipes and in the free spaces between the pipe plates to be clearly lower than the minimum LNG pressure, so that the pressure increase that occurs in the event of a leak, due to natural gas entering in, triggers the safety pressure switch provided for this purpose and triggers shut-off of the LNG feed by way of this switch. The disadvantage that the heat transfer surface area must be increased due to the increased thermal resistance in the pipe-bundle heat exchanger, so as to ensure the required heat transition energy, is compensated by the possibility now given, of selecting a liquid intermediate medium that is equally effective and cost-advantageous. In this regard, Therminol D12 is an advantageous solution. This is a synthetic heat medium fluid on the basis of aliphatic hydrocarbons, which, as a heat medium fluid, does not freeze at temperatures as low as −85° C., and is capable of being pumped, is not harmful to the environment in the event of a leakage due to failure, and is permissible for occasional unintentional contact with food.

The liquid intermediate medium transports the refrigeration energy in the transport chamber of the refrigerated vehicle; in other words it absorbs the heat to be transported to the LNG from the air to be cooled. For this purpose, a ribbed-pipe heat exchanger to which the liquid intermediate medium is applied on the outside and to which the cooling chamber air conveyed by a fan is applied on the outside is used. The heat transfer on the outside can be implemented by means of high ribs and by means of the high flow velocity of the air, and the heat transfer on the inside can be implemented by means of the high flow velocity of the intermediate medium, in such advantageous manner that the thermal resistance of the heat transition is minimized and the temperature of the intermediate medium, which is thereby maximized, results in a reduced viscosity and thereby in a correspondingly low drive energy of the re-circulation pump that ensures the forced circulation.

### EXEMPLARY EMBODIMENT

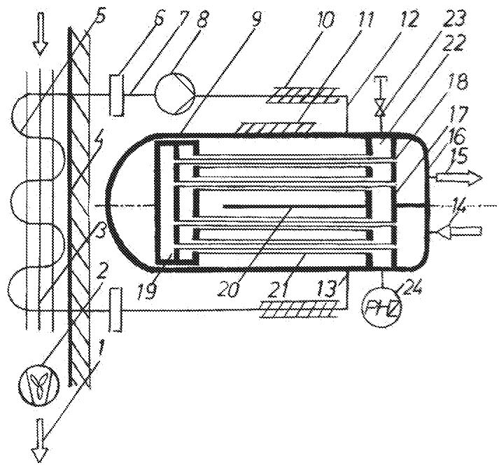

In the following exemplary embodiment, the invention will be explained in greater detail using a schematic representation, in FIG. 1, of the heat transfer device structured according to the invention, for the provision of refrigeration in refrigerated vehicles, the motor vehicle engine of which is operated using LNG.

All of the components subject to a low temperature level due to the LNG consist of cryogenic material. All components at low temperatures are protected from undesirable incident heat by means of insulation.

The cryogenic LNG carried in the refrigerated vehicle in a storage unit is re-gasified in the pipe-bundle heat exchanger (9) provided for this purpose, so as to power the motor vehicle engine as gaseous natural gas (15). The heat required here for evaporation of the LNG is transferred by means of the heat-discharging material stream of a liquid intermediate medium (5), which medium is conducted in forced circulation in a hermetically sealed heat transfer circuit, using flexible hose lines (7) and a re-circulation pump (8) at the inlet and outlet (12, 13) of the intermediate medium (5) into and out of the mantle chamber, and in turn obtains the heat from the cooling air (1) re-circulated in the transport chamber of the refrigerated vehicle with a fan (2), using a ribbed-pipe heat exchanger (3), as refrigeration energy.

The LNG evaporator is structured as a pipe-bundle heat exchanger (9) having a floating head and two mantle paths, so that the great temperature changes, in terms of time and space, that occur during operation do not cause any uncontrollable mechanical stresses.

The cryogenic LNG supplied at the LNG inlet (14) enters by way of the heat transfer hood (16) and is distributed to the heat transfer pipes (18) that carry the LNG, by way of a pipe plate (17), flows to the deflection hood (19) in the floating head of the pipe-bundle heat exchanger (9), is deflected, and flows back to the pipe plate (17), once again conducted in heat transfer pipes (18), and from there gets into the upper part of the heat exchanger hood (16) divided by a partition, and finally reaches the internal combustion engine of the refrigerated vehicle, by way of the outlet connector (15), partially or completely re-gasified, directly or by way of an additional heat exchanger operated with waste engine heat.

All of the heat transfer pipes (18) of the pipe-bundle heat exchanger (9) that carry LNG are surrounded by coaxially running protective pipes (21), which are carried by additional pipe plates provided for this purpose, so that the interstice between the heat transfer pipes (18) that carry LNG and the protective pipes (21), as well as the spaces between the pipe plates at the ends, filled with a dry gas (22) as a protective gas, act as a thermal resistance that is superimposed on the usual transport resistance of the heat transition through a simple pipe wall. A clearly increased driving temperature difference results from the thermal resistance that is thereby increased in targeted manner and clearly counteracts the heat transport from the intermediate medium (5) to the LNG, and this has the result that the surface temperature of the protective pipes (21) wetted by the intermediate medium (5) is clearly greater than that of the LNG, which has a temperature as low as −161° C. With this prerequisite, in other words in the case of a corresponding selection of the layer thickness of the dry protective gas (22), for example nitrogen or air, which thickness is generally very thin, intermediate media (5) are available, which neither freeze nor can no longer be pumped due to overly high viscosity.

The disadvantage, that because of the increased thermal resistance in the LNG evaporator the heat transition surface has to be increased to ensure the required heat transition, is compensated by the possibility that now exists, of selecting a liquid intermediate medium (5) that is both equally effective and cost-advantageous. In this regard, Therminol D12 is an advantageous solution. This is a synthetic heat medium fluid on the basis of aliphatic hydrocarbons, which is capable of being pumped as a heat medium fluid down to as low as −85° C., which is not harmful to the environment in the event of a leak due to failure, and which is permissible for occasional unintentional contact with foods. The intermediate medium (5) enters into the mantle space of the pipe-bundle heat exchanger (9), divided by a partition plate (20), via the connector at the inlet (12), and flows to the connector at the outlet (13) by way of the resulting two mantle paths, in a flow opposite to the LNG.

As a further safety-technology measure, it is proposed that the pressure of the dry gas (22) hermetically sealed between the coaxial pipes and in the free spaces between the pipe plates be selected to be clearly lower than the minimum LNG pressure, so that the pressure increase occurring in the event of a leak, due to natural gas entering in, triggers the safety pressure switch (24) provided for this purpose and, via this switch, triggers shut-off of the LNG feed.

The liquid intermediate medium (5) transfers the refrigeration energy in the transport chamber of the refrigerated vehicle; in other words, it absorbs the heat to be transported to the LNG from the cooling chamber air (1). For this purpose, a ribbed-pipe heat exchanger (3) to which the liquid intermediate medium (5) is applied on the inside and to which the cooling chamber air conveyed by a fan (2) is applied on the outside.

The heat transition on the outside can be implemented by means of high ribs and by means of the great flow velocity of the cooling chamber air (1), and the heat transition on the inside can be implemented by means of the high flow velocity of the intermediate medium (5), in such advantageous manner that the thermal resistance of the heat transition is minimized and the temperature of the intermediate medium (5), which is thereby maximized, results in reduced viscosity and thereby in a correspondingly low drive energy of the recirculation pump (8) that ensures the forced circulation.

Furthermore, the environmental friendliness of the intermediate medium (5) ensures that the circuit, conveyed in insulated, partially flexible hose lines (7), can be opened up using quick-lock couplings (6) that shut off on both sides, so as to separate the trailer of a semi-trailer from the truck unit, for example.

### REFERENCE SYMBOL LIST

LNG liquefied natural gas (liquified natural gas)
NG re-gasified natural gas
Rₜₕ thermal resistance
\dot{Q} heat energy
ΔT temperature difference
PHZ pressure, upper limit value, protection by means of triggering or safety-relevant switching function
1 cooling chamber air
2 fan
3 ribbed-pipe heat exchanger
4 insulated cooling chamber wall
5 heat-transferring intermediate medium
6 quick-lock coupling that shuts off on both sides
7 flexible line
8 re-circulation pump
9 pipe-bundle heat exchanger (having a floating head and two mantle paths)
10 insulation
11 insulation
12 inlet of the intermediate medium into the mantle chamber
13 outlet of the intermediate medium out of the mantle chamber
14 LNG inlet
15 outlet connector for evaporated LNG
16 heat exchanger hood with partition and LNG connector(s)
17 pipe plate
18 LNG-carrying heat transfer pipe
19 deflection hood (in the floating head of the pipe-bundle heat exchanger)
20 partition plate (in the mantle chamber of the pipe-bundle heat exchanger)
21 protective pipe (coaxial to the LNG-carrying pipe)
22 dry gas (as a hermetically sealed protective gas)
23 service valve
24 safety pressure switch (closes the LNG feed in the event of increasing pressure)

1-5. (canceled)

6: A heat transfer device for the provision of refrigeration in refrigerated vehicles, by means of evaporation of liquefied natural gas (LNG),
wherein the re-gasified natural gas (NG) is provided for operating the engine of the refrigerated vehicle, on the one hand, and the available refrigeration energy can be utilized for cooling of the refrigerated goods to be transported using the refrigerated vehicle, on the other hand;
wherein a ribbed-pipe heat exchanger (3) arranged in the cooling chamber stands in an active connection with a pipe-bundle heat exchanger (9) as an LNG evaporator, with strict spatial separation, whereby heat can be extracted from the cooling chamber, and heat can be conducted away by means of cooling chamber air (1) conveyed by means of a fan and the ribbed-pipe heat exchanger (3), specifically making use of a liquid intermediate medium (5) conducted in a closed circuit, in forced circulation between the ribbed-pipe heat exchanger (3) and the pipe-bundle heat exchanger (9), which medium, as a synthetic heat medium fluid on the basis of aliphatic hydrocarbons, does not freeze at temperatures as low as −85° C. and remains capable of being pumped, is not harmful to the environment in the event of a leak, and is permissible for occasional unintentional contact with foods;
wherein a pipe-bundle heat exchanger (9) produced from cryogenic material is used for evaporation of the LNG that flows in via the LNG inlet (14), which exchanger conducts the LNG to be evaporated in the heat exchanger pipes (18) and conducts the heat-transferring intermediate medium (5) from the inlet (12) to the outlet (13) in the mantle chamber, and is structured as a pipe-bundle heat exchanger (9) having a floating head and two mantle paths, whereby the great temperature changes in terms of time and space that occur during operation exclusively cause controllable mechanical stresses; and
wherein coaxially arranged protective pipes (21) sheathe the LNG-carrying heat transfer pipes (18) in such a manner that a hermetically sealed interstice that can be filled with a dry gas (22) is formed, the low layer thickness of which, between the pipes (18 and 21), is designed in such a manner that here, the thermal resistance (Rₜₕ) leads to a temperature drop that excludes freezing of the intermediate medium (5) at the surface of the protective pipe (21).

7: The heat transfer device according to claim 6, wherein the pressure of the hermetically sealed dry gas (22) is selected to be clearly lower than the minimum LNG pressure, whereby it is ensured that the pressure increase that occurs in the event of a leak, due to natural gas entering in, triggers the safety pressure switch (24) provided for this purpose and triggers shut-off of the LNG feed by way of this switch.

8: The heat transfer device according to claim 6, wherein the heat can be transferred from the cooling chamber air (1) conveyed by a fan (2) to the ribs of the ribbed-pipe heat exchanger (3) to which intermediate medium (5) is applied on the inside, at which exchanger the heat transition can be implemented on the outside by means of high ribs and by means of a great flow velocity of the cooling chamber air (1), and the heat transition on the inside can be implemented by means of a high flow velocity of the intermediate medium (5), in such advantageous manner that the thermal resistance (Rₜₕ=ΔT/\dot{Q}), in other words the quotient of the driving temperature difference (ΔT) that decreases at the resistance and the heat energy (\dot{Q}) of the heat transition is minimized, and the temperature of the intermediate medium (5), which is thereby maximized, results in reduced viscosity and thereby in a correspondingly low drive energy of the recirculation pump (8).

9: The heat transfer device according to claim 6, wherein the intermediate medium (5) that transports the heat from the ribbed-pipe heat exchanger (3) to the pipe-bundle heat exchanger (9) is conducted in lines (7) that are provided with insulation (10) and are at least partially flexible, which lines can be separated using quick-lock couplings that shut off on both sides.
